(19) United States
(12) Patent Application Publication
(10) Pub. No.: US 2024/0261815 A1
(43) Pub. Date: Aug. 8, 2024

(54) COATING DEVICES AND METHOD FOR ARTICLES

(71) Applicant: Sonoco Development, Inc., Hartsville, SC (US)

(72) Inventors: Brian Daniel Guzzi, Hartsville, SC (US); Robert Thor Versluys, Florence (IS); Robert Joseph Brown, Hartsville, SC (US)

(21) Appl. No.: 18/107,306

(22) Filed: Feb. 8, 2023

(51) Int. Cl. B05C 13/02; B05C 7/04; B05C 11/10

(52) U.S. Cl. CPC B05C 13/02; B05C 7/04; B05C 11/10

(57) ABSTRACT

In an embodiment, the invention comprises a method of coating a three-dimensional article comprising depositing a quantity of a liquid coating material onto a surface of a form factor, contacting a surface of the three-dimensional article with the form factor surface, wherein the form factor surface is configured to nest with the three-dimensional article. The method further comprises coalescing the liquid coating material on the surface of the three-dimensional article for uniform coverage.

### FIELD OF THE INVENTION

The present invention relates generally to coating devices and methods for coating three dimensional articles, such as food containers.

### BACKGROUND OF THE INVENTION

Providing a coating for a three-dimensional article requires a method that maximizes coverage of the coating over the various surfaces of the article, minimizes the weight of the coating, and minimizes coating material losses. Through ingenuity and hard work, the inventors have developed coating devices and methods which provide coatings for such articles. The methods provide a uniform coating on contoured surfaces, particularly for concave or hollow surfaces, minimize the coating weight, and minimize liquid coating waste.

The apparatus of the invention comprises means for applying a liquid coating to a surface of an article, a means for removing the excess of liquid coating from the coated surface, and a means for recovering excess coating for reuse during the coating process.

### SUMMARY OF THE INVENTION

In an embodiment a method of coating a three-dimensional article is provided. The method comprises depositing a quantity of a liquid coating material onto a surface of a form factor. The method continues by contacting a surface of the three-dimensional article with the form factor surface. The form factor surface is configured to nest with the three-dimensional article. The method continues by coalescing the liquid coating material on the surface of the three-dimensional article for uniform coverage.

In some embodiments, the coalescing the liquid material may comprise one of rotating the three-dimensional article about an axis at a speed sufficient to remove excess coating from the three-dimensional article, aiming a stream of air at the surface of the three-dimensional article, utilizing ultrasonic waves, vacuuming excess liquid coating or heating the three-dimensional article. In some embodiments, coalescing the liquid coating may further comprise metering the liquid coating material on the surface of the three-dimensional article.

In some embodiments, the method may further comprise rotating the three-dimensional article on the form factor surface. In some embodiments, the depositing step may comprise flood coating the surface of the three-dimensional article. In some embodiments, the depositing step may comprise directing the liquid coating material upwardly over the form factor such that the liquid coating material flows downwardly over the form factor.

In some embodiments, the surface of the three-dimensional article may be concave. In some embodiments, the three-dimensional article may be symmetrical. In some embodiments, the three-dimensional article may be asymmetrical. In some embodiments, the three-dimensional article may be retained by a vacuum. The vacuum may create a pressure adjacent a surface opposite the surface of the three-dimensional article to be coated which is lower than the pressure adjacent the surface of the three-dimensional article to be coated.

In another example embodiment a device for coating a three-dimensional article is provided. The device comprises a form factor defining a form factor surface configured to nest with a surface of the three-dimensional article. The form factor further comprises at least one opening in the form factor surface. The device further comprises means for retaining the three-dimensional article and means for supplying a liquid coating material through the at least one opening. The liquid coating material is configured to flow over the form factor surface.

In some embodiments, the means for retaining the three-dimensional article may be configured to move the three-dimensional article into contact with the form factor surface. In some embodiments, the form factor surface contacts a surface of the three-dimensional article. The contact between the form factor surface and the surface of the three-dimensional article coats the surface of the three-dimensional article with the liquid coating material. In some embodiments, the means for retaining the three-dimensional article may be configured to rotate.

In some embodiments, the form factor may be formed of one of an elastic material, a semi elastic material, a plurality of fabric strands or a sponge. In some embodiments, the form factor may be formed of a semi elastic material. In some embodiments, the form factor may further comprise at least one vacuum opening, the one vacuum opening being distinct from the at least one opening.

In yet another example embodiment a system for coating an article with a coating material is provided. The system comprises a coating device. The coating device comprises a form factor comprising a central column defining a through hole, and a tubular column extending through the central column. The system further comprises a pump in fluid connection with the tubular column. The system further comprises a reservoir comprising the coating material, the reservoir being in fluid communication with the pump. The system further comprises retention means configured to move the article into and out of contact with the coating device.

In some embodiments, the central column and the tubular column may be liquid tight. In some embodiments, the central column may be one of a tube, a pipe, a hose, or a column.

In some embodiments, the pump may provide a pump pressure configured to displace the coating material over the form factor. In some embodiments, the pump may provide a pump pressure configured to provide an even flow of the coating material over the form factor.

In some embodiments, the retention means may be a vacuum device. In some embodiments, the retention means may comprise one of pneumatically-actuated mechanical grippers, solenoid-actuated grippers, centrifugal-actuated hinged sling weight grippers, or spring loaded grippers, and a mechanical ejector. In some embodiments, the retention means device may be configured to contact an exterior surface of the article.

In some embodiments, the form factor may further comprise a plurality of outlet holes and a plurality of central columns. Each of the plurality of central columns may correspond to one of the plurality of outlet holes. In some embodiments, the form factor may further comprise a plurality of vacuum inlet holes.

The accompanying drawings, which are incorporated in and constitute a part of this specification, illustrate one or more embodiments of the invention and, together with the description, serve to explain the principles of the invention.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 illustrates a method of coating, in accordance with some embodiments described herein;

FIG. 2 illustrates an embodiment of a process for coating a container, in accordance with some embodiments described herein;

FIGS. 3A and 3B illustrate an embodiment of a coating device, in accordance with some embodiments described herein;

FIG. 4 illustrates a method of coating, in accordance with some embodiments described herein;

FIG. 5 illustrates an alternative method of coating, in accordance with some embodiments described herein;

FIG. 6 illustrates yet another method of coating, in accordance with some embodiments described herein;

FIG. 7A illustrates a top view of an example form factor within a coating device, in accordance with some embodiments described herein;

FIG. 7B illustrates a cross-sectional view of the example form factor shown in FIG. 7A, in accordance with some embodiments described herein;

FIG. 7C illustrates a bottom view of the example form factor shown in FIG. 7A, in accordance with some embodiments described herein;

FIG. 8 illustrates another embodiment of a coating device, in accordance with some embodiments described herein;

FIG. 9 illustrates yet another embodiment of a coating device, in accordance with some embodiments described herein;

FIG. 10 illustrates yet another embodiment of a coating device, in accordance with some embodiments described herein;

FIG. 11 illustrates yet another embodiment of a coating device, in accordance with some embodiments described herein; and

FIGS. 12A-F illustrate example positioning of an article on an example rotation table, in accordance with some embodiments described herein.

Repeated use of reference characters in the present specification and drawings is intended to represent the same or analogous features or elements of the invention.

### DETAILED DESCRIPTION

Reference will now be made in detail to embodiments of the invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations as come within the scope of the appended claims and their equivalents.

In an embodiment, the present invention provides a coating method for an article, such as a container for food products (raw or cooked, frozen or refrigerated). The containers may be configured to contain food that can be heated and/or reheated directly in the container. In some cases, the containers are referred to as ‘ovenable,’ as in capable of being reheated in an oven, microwave, or other heating mechanism.

The coating methods discussed herein could be used in connection with a polymeric or plastic container, a pressed paperboard container, a fiberglass container, a folded paperboard container, a corrugated cardboard container, a metal container, a glass container, a fiber-based container, or any other container known in the art. The methods could be used with a thermoformed container, a spirally-wound container, a compression-molded container, an injection-molded container, a fiberglass container, etc. The article could comprise a symmetrical article (i.e., a bowl) or a non-symmetrical article (i.e., an asymmetrically partitioned tray).

If a polymeric material is utilized, the polymer may comprise polyethylene, polyethylene terephthalate, polypropylene, cellulose acetate, cellulose diacetate, cellulose triacetate, nylon, poly lactic acid (PLA), poly-3-hydroxybutyrate (PHB), polyhydroxyalkanoates (PHA), nitrocellulose, or any other polymer material known in the art.

If a paper material is utilized, the paper may comprise paperboard, cardstock, cardboard, hardwood or any other paper material known in the art.

If a fiber is utilized, the fiber composition may comprise bagasse, softwood, bamboo, sugarcane, eucalyptus, wheat, straw, corn, newsprint, old corrugated containers, wood, or any other commercially available type of paper stock, including paper mill sludge or any combination of fiber sources. The pulp may be virgin or recycled. In some embodiments, a polymeric material may be formed into a resin-based fiber, for example polyethylene terephthalate fibers or polypropylene fibers.

In some embodiments, the coating material may be coated onto the interior of a container. In an embodiment, the coating methods may be useful for bowls, trays, cups, cartons, dishes, plates, multi-compartment plates, cylindrical cans or canisters, boxes, or any other receptacles. In an embodiment, the interior of the container may be concave, hollow, or contoured for receipt of food, beverage, pharmaceutical, nutritional, and/or other items. However, the article to be coated could comprise any shape known in the art—flat, concave, convex, irregular, or any three-dimensional shape known in the art. The article may have multiple compartments, in an embodiment. The article may be a single-use container or a multi-use container. Likewise, more than one surface of an article can be coated using the present process.

In an embodiment, the article need not be a container at all and may comprise any article known in the art. For example, the article may comprise a toy, a mobile phone case, a book cover, a piece of furniture, or any other three-dimensional object that would benefit from a coating material. In an embodiment, the article need not be three-dimensional and may be two-dimensional.

In an embodiment, the coating may provide an oil, water vapor and/or moisture barrier material. Likewise, the coating could be designed to provide additional surface strength, improve cut resistance, improve UV-resistance, or add to the aesthetic appearance of the article. For example, the coating may add color, patterns, textures and sheen to the surface of the article. One may also coat an article to protect an underlying print or to improve its printability.

As discussed herein, in an embodiment, the coating may be a liquid coating. In an embodiment, the coating is an aqueous dispersion. In some embodiments, the liquid coating material may be water-based, may be epoxy resin, may be polyurethane, or a similar coating. In an embodiment, the coating may comprise a water-based acrylic copolymer. In some embodiments, the coating may itself be a dry powder. In some embodiments, the dry powder may adhere to the three dimensional article electrostatically which may be cured utilizing thermal curing. In some embodiments, a dry powder may be added to and intermixed with a liquid coating prior to curing, while in other embodiments a dry powder may be applied over a liquid coating before or after curing. Additional examples of coating materials are disclosed herein.

In an embodiment, a coating material may be coated onto at least one surface of an article. In an embodiment, a coating material may be coated onto at least two surfaces of an article (i.e., the interior of a container and the underside of the rim of the same container). In an embodiment, a coating material may be coated onto all of the surfaces of an article.

### The Coating Methods

The methodology of the coating process may comprise any of several embodiments, including combinations thereof. In some embodiments, the article of the invention may be spray coated, flood coated, dipped in coating, filled with coating, print coated, submerged in coating, or fountain coated, as a few non-limiting examples.

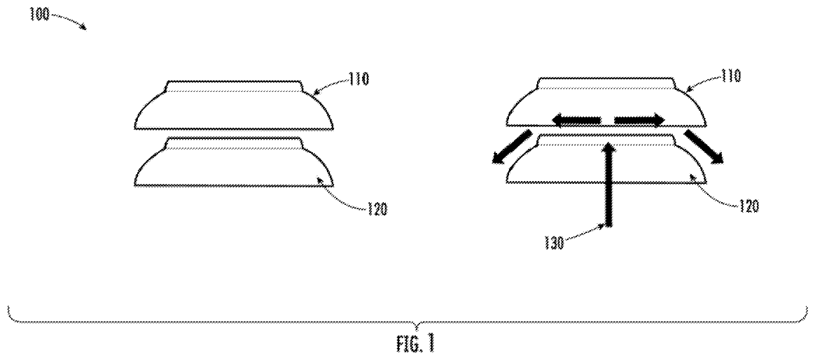

An example coating process 100 is illustrated in FIG. 1. An article or container 110 may be configured to engage with and/or mate with a coating device 120. A liquid coating material 130 may be configured to flow over the coating device 120 such that the article 110 may be brought into contact with the coating device 120 such that the liquid coating material 130 coalesces on the article 110.

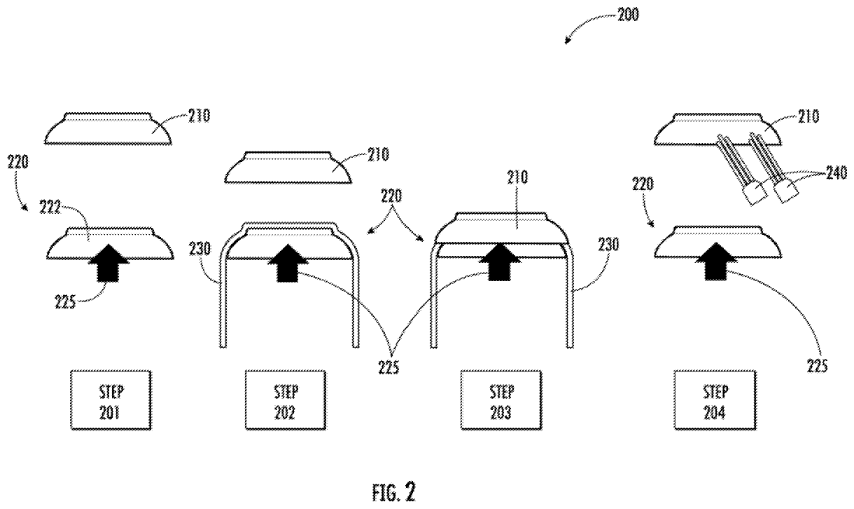

Another example coating process 200 is shown in FIG. 2. In this exemplary illustration, a coating device 220 is shown in Step 201 with the container 210 to be coated positioned above the coating device 220. The article or container 210 is disposed such that the surface to be coated faces the coating device 220. In an embodiment, the container is positioned in an inverted manner, such that the interior of the container 210 faces the coating device 220. In an embodiment, the container 210 is positioned above the coating device 220, but this should not be limiting. The container 210 may be positioned horizontally or angularly from the coating device 220, in some embodiments. The arrow 225 represents the flow of the liquid coating material through the coating device 220 (upward, in this embodiment). More specifically, in this embodiment, the liquid coating material is pumped upwardly, through and over a form factor 222 (also referred to herein as a head portion) of the coating device 220.

In the embodiment shown in the figures, one container 210 is being coated by the coating device 220, but this should not be limiting. For example, several small articles may be simultaneously coated about the circumference of the coating device 220, in an embodiment. Likewise, the coating device 220 could be sized and configured to be much larger than the articles to be coated, allowing a plurality of articles to be simultaneously coated. Still further, the coating device 220 could be sized and configured to mate with a plurality of articles simultaneously or in a sequential action.

As shown in Step 202, the liquid coating material flows upwardly 225 through the coating device 220 while additionally flowing outwardly and downwardly 230 (primarily due to gravitational forces, but surface tension and other factors may also contribute), over the head of the coating device 220, and optionally returning to a reservoir disposed beneath the coating device 220 (though the reservoir could be located in any location known in the art, such as downstream from the coating device). In an embodiment, the liquid coating material flows in a waterfall- or fountain-like manner. In an embodiment, the liquid coating material flows equally or substantially equally over the full surface area of the outer surface of the form factor of the coating device 220. In an embodiment, the liquid coating material may form a continuously flowing laminar sheet on the exterior surface of the form factor. In an embodiment, the liquid coating may fall from the form factor in the form of a liquid laminar curtain, into a reservoir below. All surfaces, ridges, contours, concavities, convexities, curves, and the like, of the form factor are covered by a flowing laminar sheet of the liquid coating material, in this embodiment. In an embodiment, the laminar sheet of the liquid coating material covers the entirety of the exterior surface of the form factor. In an embodiment, all three hundred and sixty degrees(360°) of the form factor are coated by the liquid coating laminar sheet. Also shown in Step 202, the container 210 begins to be lowered downwardly, toward the coating device 220.

At Step 203, the container 210 is lowered onto the form factor of the coating device 220. Alternatively, the container 210 may be stationary and the form factor may move into the interior of the container 210. Likewise, the container 210 and form factor may each move toward each other in this embodiment.

In this embodiment, the interior of the container 210 (or other surface to be coated) makes full contact with the laminar sheet of coating. In some embodiments, the coating device 220 and the container 210 may be contacted one time, while in other embodiments the coating device 220 and the container 210 may be contacted multiple times. In some embodiments, multiple contacts between the coating device 220 and the container 210 may reduce air pockets within the coating material, and increase a contact time between the container 210 and the coating material. As shown, excess liquid coating material continues to flow upwardly 225 as well as outwardly and downwardly 230, between the container 210 and the form factor of the coating device 220. A pressurized pump which drives the liquid coating material upwardly through the coating device may be optimized to maintain the laminar flow between the container 210 and the form factor surface. In this manner, the entire surface of the container 210 is completely flooded with the liquid coating, including any areas of irregular shape or contour on the surface thereof (such as ridges between compartments or rims, etc.). The coating application process ensures a complete and thorough coating of the liquid coating material over the entire interior surface, or substantially the entire interior surface, of the container. Excess coating material continues to flow and is optionally collected in a reservoir beneath the form factor. In an embodiment, the excess coating is then returned to the coating device (i.e., through suction and/or the pressurized pump) and continues flowing through and over the form factor. Because the coating material is collected in the reservoir and is reused, the coating method of the invention is not wasteful of excess coating or inefficient in its coating methods. Reconditioning of the liquid coating may be carried out before reuse, if desired (e.g., replenishing coating content or water content, adding defoaming agent, further filtering, de-aeration, pH adjustment, temperature adjustment, and the like). In an embodiment, the coating method may be conducted in an open or closed environment.

In an embodiment, the container 210 and/or the form factor of the coating device 220 may rotate before, during, and/or after the coating Step 203. In some embodiments, the container 210 and/or the form factor may rotate before, during and/or after a first coating, and may be stationary during a second coating, or vice versa. This may be particularly useful if the container has a symmetrical shape, such as that of a bowl or cup. That being said, the container 210 need not have a symmetrical shape.

In this embodiment, the container 210, the form factor of the coating device 220, or both, may rotate. In an embodiment, the rotation may comprise between about ninety degrees (90°) and about one hundred eighty degrees (180°). In an embodiment, the rotation may comprise between about sixty degrees(60°) and about three hundred and sixty degrees (360°). In an embodiment, the rotation may comprise between about three hundred and sixty degrees(360°) and about seven hundred and twenty degrees) (720°). In an embodiment, the rotation may comprise a plurality of full rotations. In a particular embodiment, the rotation may comprise about three hundred and sixty degrees) (360°). In an embodiment, the rotation occurs in only one radial direction. In another embodiment, the container 210 and/or form factor of the coating device 220 rotation occurs in both radial directions—i.e., the rotation may occur in clockwise manner and then in a counterclockwise manner, or vice versa. In some embodiments, the container 210 may rotate in one radial direction and the form factor may rotate in the opposite radial direction.

In an embodiment, the rotation may begin prior to contact between the container 210 and the coating device 220. That is, the container 210, the form factor 222, or both, may begin rotating, accelerated to a target speed, and then the form factor 222 may coat the container 210.

At Step 204, the container 210 is retracted from the coating device 220. In an embodiment, this may comprise lifting the container 210 upwardly, retracting the head/form factor of the coating device 220 downwardly, or both. The container 210 may be additionally or continually rotated, in an embodiment, to ensure complete coverage of the coating on the surface to be coated. The rotation may additionally allow any excess coating material to drip from the container 210 into the reservoir. In an embodiment, this rotation may be accomplished while the container 210 is positioned angularly, tilted, inverted, or any other direction known in the art. In an embodiment, the rotation may increase in speed as the container 210 is separated from the coating device 220. In an embodiment, the speed of rotation may increase or decrease during or after retraction of the container 210 and the coating device 220. For example, there may be a first target rotational speed utilized during coating and a second target rotational speed utilized during metering/coalescence. In an embodiment, the first target rotational speed is lower than the second target rotational speed. In another embodiment, the first target rotational speed is higher than the second target rotational speed. In yet another embodiment, the first target rotational speed is substantially the same as the second target rotational speed.

In some embodiments, the first target rotational speed may be at least 300, rotations per minute, at least 400 rotations per minute, at least 500 rotations per minute, or even at least 600 rotations per minute. In some embodiments, the first target rotation speed may be up to 700 rotations per minute, up to 800 rotations per minute, or even up to 900 rotations per minute.

In an embodiment, one or more metering methods may then be utilized (shown in Step 204) to facilitate full and uniform coverage of the coating material, even out/smooth out the coating material, and/or remove any excess coating material from the container 210. The illustrated metering step comprises air knives 240, but any metering method known in the art may be utilized, as will be discussed below. In Step 204 of the process, the container may or may not be tilted or inverted (flipped over such that it is upright), in an embodiment, to accomplish the metering. The container is then dried and/or cured. In this regard, in some embodiments metering may include drying, or a curing process, for example, UV-curing, energy curing or similar. In an embodiment, the container 210 may be initially dried in an inverted position (i.e., with the coated surface facing downwardly). The container may then be positioned in its ordinary position (i.e., interior surface of the container facing upwardly) for the full drying and/or curing process.

In an embodiment, the form factor/head of the coating device 220 is shaped and configured to fit precisely within the container 210 to be coated. That is, the upper, outer surfaces of the head of the coating device 220 are shaped and configured to nest within the inner surfaces of the container 210.

In an embodiment, the form factor of the coating device 220 is flexible and/or elastically deformable, such that it can conform to the inner surfaces of the container 210. In another embodiment, the form factor of the coating device 220 comprises a sponge, pad, or rubberized material that conforms to the inner surfaces of the container 210. In other embodiments, the form factor of the coating device 220 may comprise a rigid polymer, such as a three-dimensional printed acrylonitrile butadiene styrene (ABS) polymer, or a metal, such as aluminum. In an embodiment, the container 210 is pressed firmly onto the form factor of the coating device 220, to encourage full engagement of the container surfaces with the liquid coating material.

In another embodiment, the coating material may be a dry powder. In this regard the dry-powder may be a free-flowing dry powder coating introduced the container 210 using the coating device 220. To enhance pumping or flow of the dry powder vibrations (e.g., ultrasonic waves or other) may be used to reduce the compaction, the density, and the viscosity of the dry powder. In this regard the vibrations may fluidize the powder. Example dry powders include finely ground cellulose acetate, cellulose diacetate, cellulose triacetate, nylon, poly lactic acid (PLA), Poly-3-hydroxbutrate (PBH), Polyhydroxyalkanoates (PHA), nitrocellulose, polyethylene, polyethylene terephthalate, polypropylene, or any other polymer material or polymer blend known in the art.

In some embodiments, the dry powder may be adhered to the container 210 using an electrostatic charge. While in other embodiments, a vacuum flow through the coating device 220 may be utilized. In other embodiments the container 210 may be pre-wetted utilizing a solvent such that the dry powder is retained on the container with the solvent. In some embodiments, the dry powder coating may be applied to the liquid coating material as a secondary coating.

In some embodiments, the dry powder may be metered utilizing the same methods used in conjunction with a liquid coating material, while in other embodiments no metering is necessary. In some embodiments, the dry powder material may be coalesced by heating the coated container 210 above the melting point of the dry powder. In some embodiments, the coated container 210 may be heated utilizing inferred radiation, a heated oven, or other heating method known in the art.

### The Coating Device

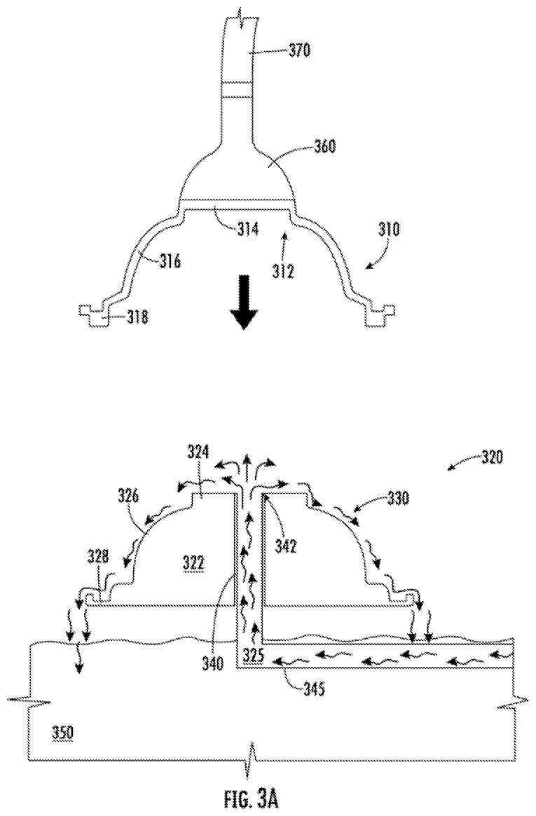

Turning to FIGS. 3A and 3B, a cross-section of an embodiment of the coating device 320 and container 310 are shown. The coating device 320 may comprise a form factor 322. The upwardly-facing, exterior surface of the form factor 322 may be sized and configured to match, nest with, or correlate with the downwardly-facing, interior size and configuration of the container 310. In some embodiments, the form factor 322 may be smaller than the container 310. In this regard the difference in the size of the form factor 322 and the size of the container 310 may define the desired thickness of the coating. In some embodiments, the coating may be at least 0.5 mm thick, at least 1 mm thick, at least 1.5 mm thick or even at least 2 mm thick. In some embodiments, the size difference between the form factor 322 and the container 310 maybe greater than the desired coating thickness, while in other embodiment the size difference may be less than the desired coating thickness. The form factor 322 may be solid, hollow, or semi solid (e.g., may contain channels and cavities).

While the container 310 shown in FIGS. 3A and 3B is illustrated as an inverted bowl, and the form factor 322 is illustrated as corresponding to that inverted bowl shape, as noted above, any shape or configuration of the article or container 310 and/or form factor 322 is contemplated herein. For example, the container 310 could be a cup, multi-compartment plate, or child's toy and the form factor 322 would be shaped in a corresponding manner (i.e., a casting, in some embodiments).

In the exemplary embodiment shown in FIGS. 3A and 3B, the container 310, shown in an inverted position (i.e., an interior surface 312 to be coated facing downwardly), comprises a base portion 314, a sidewall or bowl portion 316 extending from the base portion 314, and a rim portion 318, which comprises the terminal end of the sidewall or bowl portion 316. In this embodiment, the form factor 322 also comprises a base portion 324, a sidewall or bowl portion 326 extending therefrom, and a rim portion 328 terminating therefrom. The base portion 324 of the form factor 322 is sized and configured to fit within the base portion 314 of the container 310. The bowl portion 326 of the form factor 322 is sized and configured to fit within the bowl portion 316 of the container 310. The rim portion 328 of the form factor 322 is sized and configured to fit within the rim portion 318 of the container 310.

The specific shape, contours and configuration of the form factor 322 and container 310 are not limiting. One or more ridges, separations, sidewall portions, rim portions, or the like may be present in one or both of the form factor 322 and the container 310. If present, the sidewall may be shortened (i.e., on a plate, for example) or elongated (on a cup or cylindrical can, for example). A rim may or may not be present. The base portion 314, 324 may be a generally horizontal flattened wall or may comprise contours. The sidewall portion 316, 326 may be generally vertical or may be angular. Many variations are possible. The form factor 322 may represent a male element and the container 310 may represent a female element, such that the contours of the form factor 322 fit precisely within the contours of the container 310, in an embodiment. In other embodiments, however, the form factor 322 need not fit precisely within the contours of the container 310. That is, the form factor 322 may approximately or substantially fit within the contours of the container 310 without being an exact cast thereof. In this regard, in some embodiments, the form factor 322 may be configured to conform to the contours of the container 310, and in some embodiments the form factor 322 may be semi elastic.

The coating device 320 may comprise one or more tubular columns 340 for transportation of the liquid coating material from the reservoir 350 upwardly and over the form factor 322. In an embodiment, the tubular column 340 may be centrally located within the form factor 322. In an embodiment, the form factor 322 comprises a through hole in its uppermost surface (i.e., the base portion 324). In an embodiment, the through hole in the form factor 322 is sized and configured to receive the central column 340. In another embodiment, the form factor 322 and the central column 340 are integrally formed. In some embodiments, the fit between the through hole and the central column 340 is liquid-tight. In other embodiments, the fit between the through hole and the central column is not liquid-tight and some coating liquid may flow through the through hole and downwardly into the reservoir.

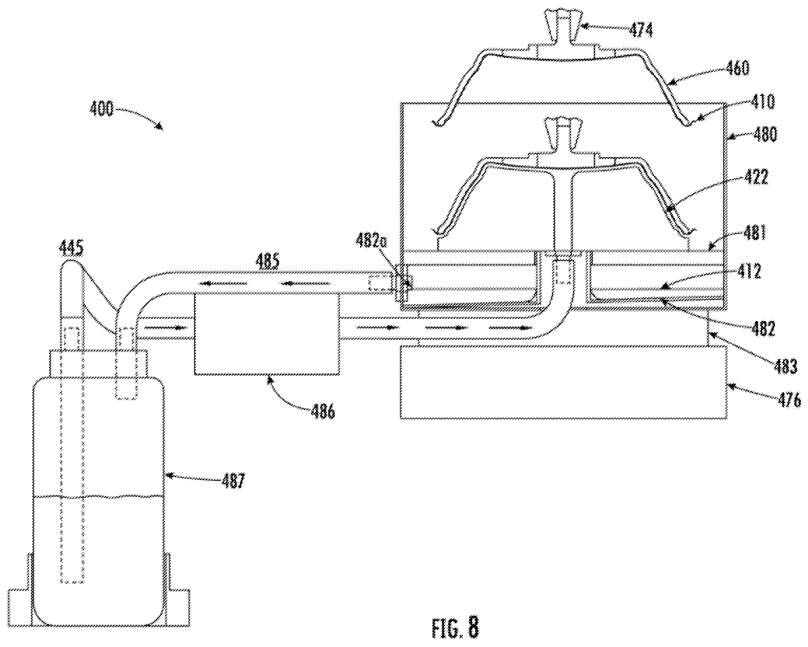

The central column 340 may comprise a tube, pipe, or other mechanism for delivery of a coating material from a reservoir to the form factor 322. One or more hoses 345 (or tubes, pipes or columns) may optionally connect to the central column 340 and connect the central column to a pump system (not shown). In an embodiment, a pneumatically-driven positive displacement pump may be used, but any pump system known in the art may be utilized. The pump (e.g., 486 FIG. 8) may be any type of pump which is capable of pumping a liquid. In an embodiment, the pump system drives the liquid coating material from the reservoir upwardly through the central column 340 to an open outlet 342 at the top of the central column 340, so that the liquid coating material may then cascade downwardly over the form factor 322. The pump pressure may be adjustable as desired but is preferably pressured such that the liquid coating material continues to flow evenly over the form factor 322, even when the container 310 contacts or is being pressed into the form factor 322.

In an embodiment, the liquid coating material may flow upwardly above the form factor 322 prior to contact with the container 310, to some extent. For example, when the pump is engaged, the coating material may travel through the column 340 and be displaced vertically above the column 340 and form factor 322 due to the pressure of the pump, such as would be the case with a fountain. In other embodiments, the upward flow of the liquid coating material may not exceed or may not substantially exceed the surface of the form factor 322.

In some embodiments, the central column 340 may comprise a nozzle at its distal or upward end. The nozzle may comprise a plurality of holes, such as 14 or 20 holes (any number of holes is contemplated), which the liquid coating material may flow through. In this embodiment, the nozzle may direct the liquid coating material upwardly and outwardly, in a spraying manner.

The form factor 322 may be supported within the coating device 320 by any means known in the art. For example, any number of form factors 322 may be positioned in a line or row and may be connected by horizontal or vertical supporting beams or bars. Likewise, the container 310 may be retained by any means known in the art. For example, a vacuum-end effector 360 may be utilized to retain and suspend the container 310 above the coating device 320. An industrial robot 370 may be used to move the vacuum-end effector (and thus, the container) into contact with and away from the coating device 320. However, any other method of retaining and moving the container 310 known in the art may be utilized in the present invention.

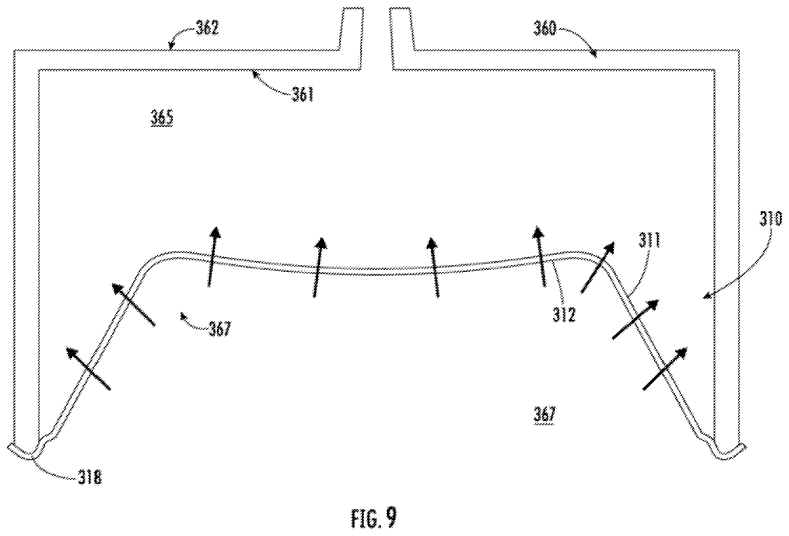

In an embodiment, the retention means for the container may comprise a vacuum device (i.e., gripper) that retains the container in an airtight or nearly airtight manner. For example, FIG. 9 illustrates a vacuum device which retains the container (i.e., bowl) about its circumferential rim 318. In an embodiment, the contact between the vacuum device 360 and the rim 318 of the bowl comprises the underside of the rim 361. In an embodiment, the vacuum device 360 does not contact (or substantially does not contact) the remainder of the container 310 (i.e., the base or sidewalls). However, in other embodiments, the vacuum device 360 may intimately contact all exterior surfaces 311 of the container (i.e., the base, sidewalls, and rim). In still other embodiments, the vacuum device 360 may intimately contact some but not all exterior surfaces 311 of the container (i.e., the base, sidewalls, and rim).

The vacuum device 360 may comprise any shape known in the art. For example, the portion of the vacuum device 360 that contacts the container 310 may be generally rectangular in cross-section as shown in FIG. 9. However, the vacuum device 360 may be square, cylindrical, spherical, may mirror the shape of the container 310, or may take any other form. In an embodiment, the vacuum device 360 securely retains the container 310 but provides space 365 between the container 310 (i.e., exterior bowl surface) and the interior walls 361 of the vacuum device 360. In other embodiments, the vacuum device 360 securely retains the container 310 via intimate contact between part or all of the container (i.e., the exterior bowl surface) and part or all of the interior walls 361 of the vacuum device 360.

In operation, the vacuum device 360 creates a vacuum (low pressure zone 365) between the container 310 (i.e., exterior bowl surface 311) and the interior surface 361 of the vacuum device 360. In this embodiment, the region surrounding the surface to be coated (i.e., the bowl interior surface 312 in FIG. 9) is not subject to a vacuum and instead has a relatively high pressure 367. In an embodiment, the region surrounding the surface to be coated (i.e., the bowl interior surface 312 in FIG. 9) may comprise ambient air or may comprise a forced high pressure. In any embodiment, there is a pressure differential between the surface to be coated (i.e., the bowl interior surface 312 in FIG. 9) and the opposite surface (i.e., the exterior surface 311 in FIG. 9), with a higher pressure being adjacent the surface to be coated. This pressure differential aids in forcing the liquid coating material into and/or through the container.

In an embodiment, the pressure differential method discussed above could be utilized in connection with a container having have high porosity, but it should not be limited in this manner. The pressure differential method will aid in the coating methods of the invention regardless of the porosity of the container. The methods disclosed herein may allow the liquid coating material to flow partially into the sidewall of a container and/or flow fully through a container having a high porosity. The pressure differential method discussed and shown in FIG. 9 may be combined with the coating methods discussed herein, or any other coating methodology discussed herein. Likewise, the pressure differential method may be combined with any metering or coalescence method discussed herein.

In other embodiments, the retention means for retaining the article/container may comprise pneumatically-actuated mechanical grippers, solenoid-actuated mechanical grippers, centrifugal-actuated hinged sling weight grippers, and/or spring-loaded grippers (toothed and/or untoothed) with a mechanical ejector. Other retention means, as are known in the art, may additionally be utilized.

Returning to FIGS. 3A-B, while the form factor 322 is shown having one through hole and a single central column 340 is shown, it should be understood that the form factor 322 may have a plurality of through holes and a correlated number of columns, tubes, or hoses which pump and deliver the liquid coating material to the exterior surface of the form factor. For example, a form factor 322 may have a central column 340 and/or may comprise a plurality of columns, pipes, or tubes circumventing the bowl portion or rim portion of the form factor. The plurality of columns, pipes, or tubes may be fitted through a plurality of corresponding through holes in the form factor 322. In this embodiment, the liquid coating material may be distributed through and over multiple outlets in the form factor 322. One or more of the plurality of columns, pipes, or tubes may have a nozzle at the form factor end. In still another embodiment, illustrated in FIG. 3B one column, pipe, or tube may deliver liquid coating material to the interior of a closed, hollow form factor 322 at such a pressure that the coating material is forced through holes 342 in the form factor 322 without the necessity of separate tubing feeding each separate through hole.

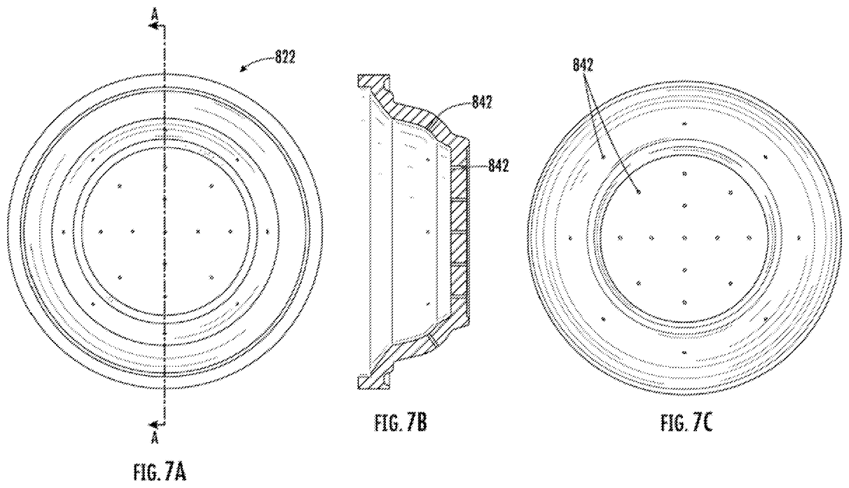

As shown in FIGS. 7A-C, in some embodiments, a form factor 822 may include a plurality of through holes 842. The liquid coating material may flow through these through holes 842 and over the outer surface of the form factor 822.

As shown in FIG. 8, in some embodiments, a coating device 400 may include a base 422 within a tank 480, which is connected to a reservoir 487 of liquid coating material 425. The liquid coating material 425 may be fed to the base 422 via an infeed tube 445 from the reservoir 487. The infeed tube 445 may supply (e.g., via a pump 486) the base 422 with the liquid coating material 425(e.g., from underneath through a spacer plate 483) such that it flows out and over the top of the base 422. A drill press 484 may be arranged above the base 422 (e.g., with a press bed 476 below the tank 480) for moving a bowl 410 (e.g., via a bowl nest 460) into and out of contact with (e.g., towards and away from) the liquid coating material 425 flowing over the top of the base 422. The base 422 may be supported by base support rods 481 positioned under the base 422 within the tank 480. The tank 480 may have an angled tank bottom 482 such that any liquid coating material 425 that flows over the top of the base 422 and to the bottom of the tank may gather at a lower end 482a of the tank. An overflow tube 485 may be arranged at the lower end 482a of the tank such that liquid coating material 425 gathered at the lower end 482a may be drained back into the reservoir 487.

While the first method of coating has been described in detail, in other embodiments, the coating may be sprayed onto the container. In other embodiments, the container may be dipped into the coating. In other embodiments, the coating may be printed onto the container. For example, in an embodiment the form factor may be a rubber material configured to mold to the shape of the article. The form factor may be dipped into a coating material, such that the coating material transfers to the form factor. The coated form factor may then be pressed on and/or into the article to transfer the coating from the form factor to the article.

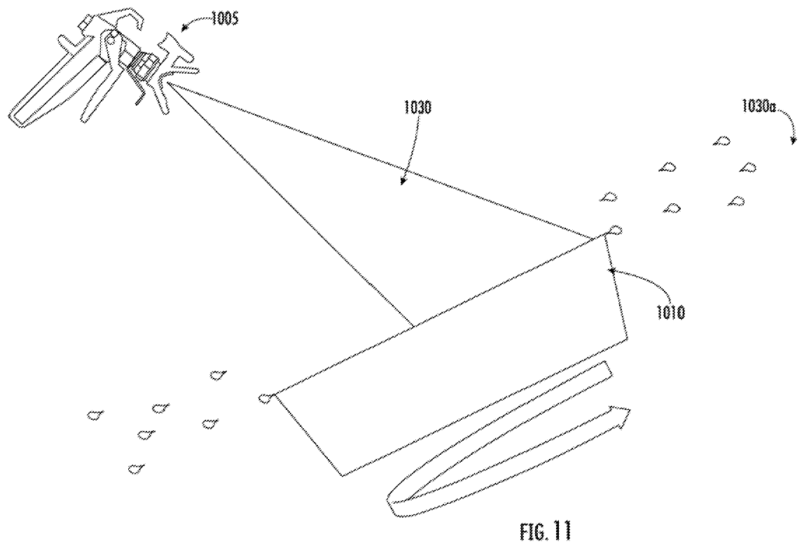

In one or more of these embodiments, the various methods of coalescence described below could be utilized. For example, with reference to FIG. 11, as will be explained herein, containers could be spray coated while being rotationally spun and then continued to be rotationally spun for coalescence purposes. In some embodiments, a spray gun 1005 may direct liquid coating material 1030 into the container 1010 to be coated. As the liquid coating 1030 is applied, the container 1010 may be rotated causing excess coating material 1030a to be removed from the container. In an embodiment, the spray gun 1005 may comprise an air atomized gun. In another embodiment, the spray gun 1005 may comprise a high-volume, low-pressure (HVLP) gun. In yet another embodiment, the spray gun 1005 may comprise an unatomized low pressure gun.

Metering and/or Coalescence

As used herein, the term “metering” refers to the removal of excess coating from the surface of a coated article and the term “coalescence” refers to the process of the coating coming together in a uniform manner, such as to avoid uncoated areas and/or pinholes. In an embodiment, as noted, a method (or methods) of metering and/or coalescence may be utilized with the first coating method or any other coating method known in the art.

In an embodiment, the metering and/or coalescence method is mechanical in nature. In an embodiment, the coating method may be utilized with one or more air knives for purposes of metering and/or coalescence (shown in FIG. 2). The one or more air knives could be stationary or could be utilized in motion, allowing the air flow to progressively pass over the container, for example. In an embodiment, the air stream(s) delivered through the air knives can be humid, for example, to retard premature drying of the coating. In some embodiments, the air stream(s) delivered through the air knives may contain atomized water droplets.

Alternatively or additionally, the metering and/or coalescence method may comprise one or more air nozzles. The air nozzle(s) may be separate from the form factor (i.e., similar to an air knife) or, in an embodiment, the air nozzle(s) may be incorporated into the coating form factor or a separate form factor. In this embodiment, the form factor may have one or more air outlets/ports in its surface which are adapted to force air out of the form factor and into the interior surface of the container. In this manner, the metering and/or coalescence step may occur as the container is being retracted from the coating form factor (or as the form factor is retracted from the container).

In an alternative embodiment, the metering and/or coalescence method may utilize ultrasonic waves. In this regard, vibration outside of the range of human hearing may excite the liquid coating material, thereby breaking up the surface tension of the coating and creating a flat uniform coating on the surface of the article.

Likewise, if a separate metering and/or coalescence form factor is utilized, the coalescence step may occur downstream after the container is retracted from the coating form factor. For example, the container may be conveyed to a second metering and/or coalescence form factor which comprises air nozzles or another form of forced air. The container may then be brought into contact or near contact with the metering and/or coalescence form factor, such that the jets, nozzles, or other forced air coalesce the coating, remove excess coating, and/or return excess coating to the reservoir (FIG. 2).

In an embodiment, the air nozzles may comprise a plurality of holes which disperse forced air in one or more directions or angles. In an embodiment, the air used in the air knives, form factor, or other jets or nozzles may be heated or humidified air.

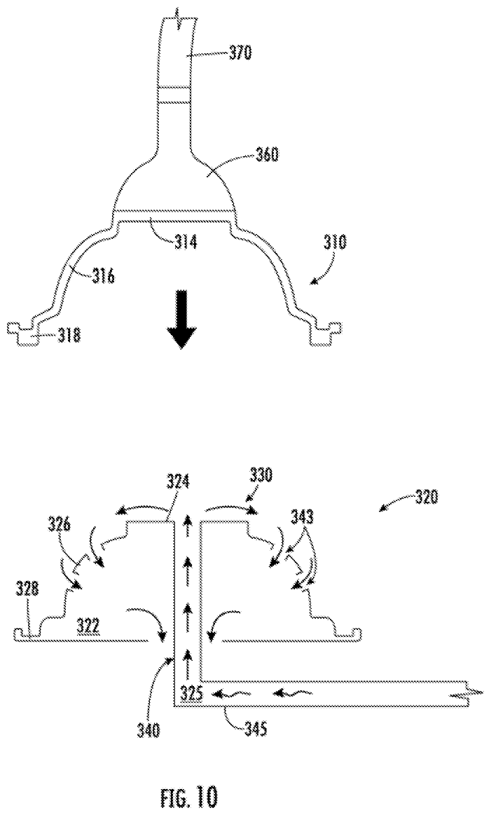

In another embodiment, illustrated in FIG. 10, the form factor 322 may comprise one or more vacuum outlets 343, such that the form factor 322 may be configured to vacuum air and/or excess coating away from the container. In this embodiment, the vacuum outlets 343 may be disposed within the surface of the form factor (i.e., via through holes) and may vacuum, or at least partially vacuum, the surface of the container as it is being retracted. Likewise, a separate vacuum may be utilized in the invention, downstream or otherwise. The vacuum, regardless of its configuration, may deposit excess liquid coating material into the reservoir for reuse.

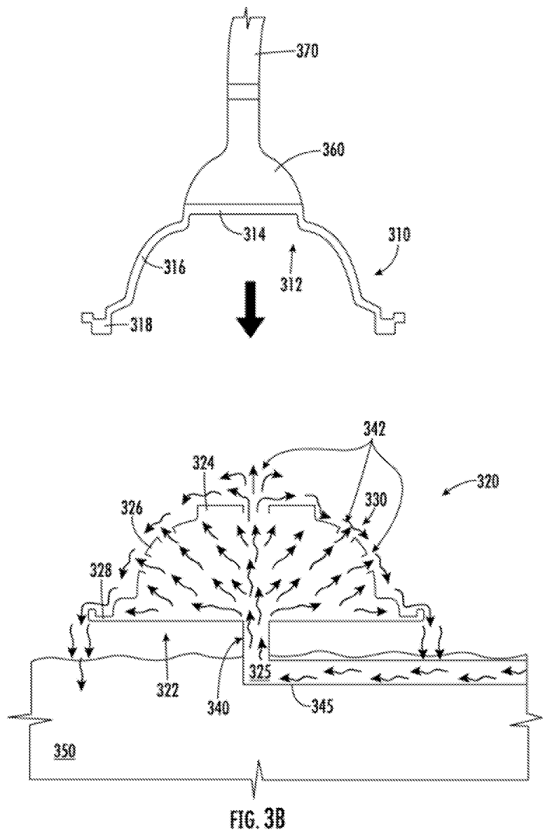

In another embodiment, the first coating method (or any other coating method) may be utilized in connection with a metering and/or coalescence plug (see FIG. 4). In this embodiment, illustrated at step 601, the plug 620 may be sized and configured to mate with the container 610, similarly to that of the form factor. Thus, if the container surface being coated is concave, the plug 620 may be convex. The plug 620 may have ridges and curves which match and nest with those of the container 610, similar to what was described above with regard to the form factor.

In an embodiment, the plug 620 may be flexible, porous, and/or a sponge-like material. In this embodiment, illustrated at step 602, the plug 620 itself may be compressible when contacted by the container 610. This may be particularly useful for a rigid container. Alternatively, the plug 620 may comprise a hard material which allows for compression of a container 610 when the container 610 contacts the plug 620. This embodiment may be particularly useful if the container 610 is a semi-flexible fiber-based container. The plug 620 may be fitted into the container 610, for example, by lowering the container 610 onto the plug 620, raising the plug 620 into the container 610, or a combination thereof. The plug 620 may be pressed into the surface of the container 610 (or the container pressed into the plug) to force coalescence.

In some embodiments, the plug 620 may be primed with the coating or a diluted version of the coating. For example, the primer material may comprise the liquid coating with additional water content. The priming may comprise coating the plug 620 with the primer material so that it is not dry upon contact with the container 610. In an embodiment, the primed plug thins out the applied coating on the container.

In an embodiment, illustrated at step 603, the plug 620 may be rotated within the container 610 if the container 610 is a symmetrical shape, such as a bowl. In this embodiment, the plug 620 may rotate or the container 610 may rotate. In an embodiment, the rotation may comprise between about two degrees(2°) and about five degrees (5°). In an embodiment, the rotation may comprise between about three degrees) (3° and about ten degrees (10°). In still another embodiment, the rotation may comprise between about one hundred eighty(180°) and about three hundred sixty degrees (360°). In an embodiment, the rotation occurs in only one radial direction. In another embodiment, the plug/container rotation occurs in both radial directions—i.e., the rotation may occur in clockwise manner and then in a counterclockwise manner, or vice versa. If rotated in both directions, the rotation may alternate three or more times.

The rotation of the plug 620, in an embodiment, may occur at any speed. The rotation may be slow-speed or high-speed. In a particular embodiment, the plug rotation may smooth down any raised fibers if the container being coated is a fiber-based container. In any case, the plug 620 may be designed to remove excess coating from the container and/or to ensure a pinhole free coating—that is, to ensure that all desired surfaces of the container are coated. In an embodiment, the plug 620 is designed to smear the coating onto and/or into the relevant surface of the container.

In an embodiment, the plug 620 may vibrate, optionally ultrasonically, to aid in coalescence of the liquid coating. The vibration may occur during contact with and/or compression with the container surface. In another embodiment, the plug 620 may be heated, which may aid in coalescence, thinning, and/or drying of the coating. The heating may occur during contact with and/or compression with the container surface.

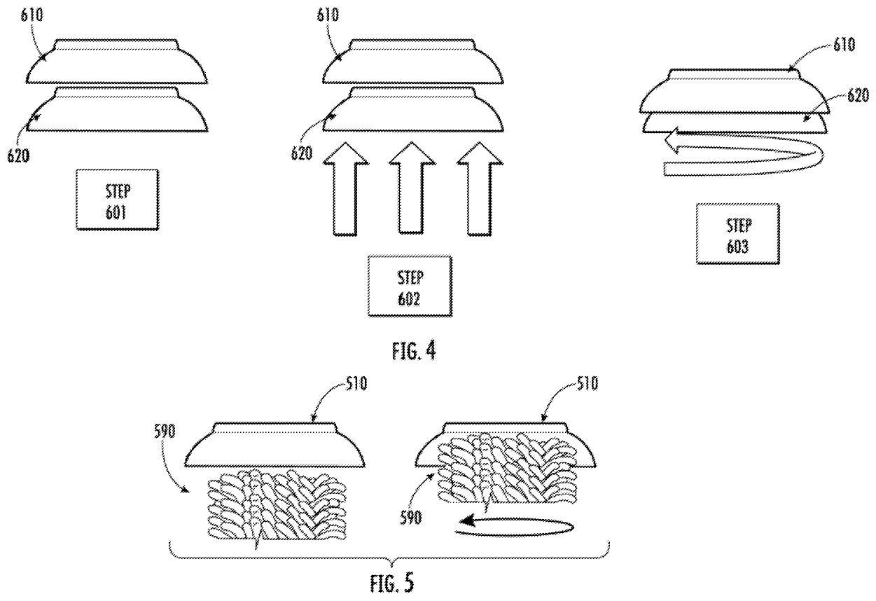

In another embodiment, the first coating method (or any other coating method) may be utilized in connection with a metering and/or coalescence mopping head 590 (see FIG. 5). In this embodiment, the head 590 may comprise a plurality of non-porous, flexible strands affixed to a central support. The strands may comprise a fabric, fiber, sponge, or any other material known in the art. Like a mop, the metering and/or coalescence mopping head 590 may be inserted into the container after coating and may be rotated. In an embodiment, the rotation may comprise between about two degrees) (2°) and about three hundred sixty degrees (360°). In an embodiment, the rotation may comprise between about sixty degrees(60°) and about one hundred eighty degrees) (180°.

In an embodiment, the rotation occurs in only one radial direction. In another embodiment, the mopping head/container rotation occurs in both radial directions—i.e., the rotation may occur in clockwise manner and then in a counterclockwise manner, or vice versa. If rotated in both directions, the rotation may alternate three or more times. For example, the mopping head 590 may rotate clockwise and counterclockwise, alternating, between one and five times in each direction. In an embodiment, the mopping head 590 may wipe the coated surface of the container, forcing coalescence.

The rotation of the mopping head 590, in an embodiment, may occur at any speed. The rotation may be slow-speed or high-speed. In a particular embodiment, the mopping head rotation may smooth down any raised fibers if the container being coated in a fiber-based container. In any case, the mopping head 590 may be designed to remove excess coating from the container 510 and/or to ensure a pinhole free coating—that is, to ensure that all desired surfaces of the container are coated. In an embodiment, the mopping head 590 is designed to smear the coating onto and/or into the relevant surface of the container 510.

In an embodiment, the mopping head 590 may vibrate, optionally ultrasonically, to aid in coalescence of the liquid coating. The vibration may occur during contact with and/or compression with the container surface. In another embodiment, the mopping head 590 may be heated, which may aid in coalescence, thinning, and/or drying of the coating. The heating may occur during contact with and/or compression with the container surface.

In some embodiments, the mopping head 590 may be primed with the coating or a diluted version of the coating. For example, the primer material may comprise the liquid coating with additional water content. The priming may comprise coating the mopping head 590 with the primer material so that it is not dry upon contact with the container. In an embodiment, the primed mopping head 590 thins out the applied coating on the container.

In a further embodiment, the metering and/or coalescence may be accomplished through rotational spinning of the coated container or article. More particularly, the invention comprises spinning the container or article at an appropriate rotational speed to force the coating to lay flat on the surface of the container or article and, additionally, expel excess coating material from the surface. This method of metering and coalescence is particularly useful in connection with non-flat paper-based articles, but could be utilized with any article.

In an embodiment, the container is retained by a mechanism 370 that allows for (1) retention of the container 310 (using suction or a vacuum, for example), (2) movement of the container 310 (using robotic, for example), and (3) rotational spinning of the container 310. In another embodiment, however, the mechanism may retain and spin the container 310, but not necessarily move the container 310 (i.e., the coating apparatus may move toward the container during the coating stage).

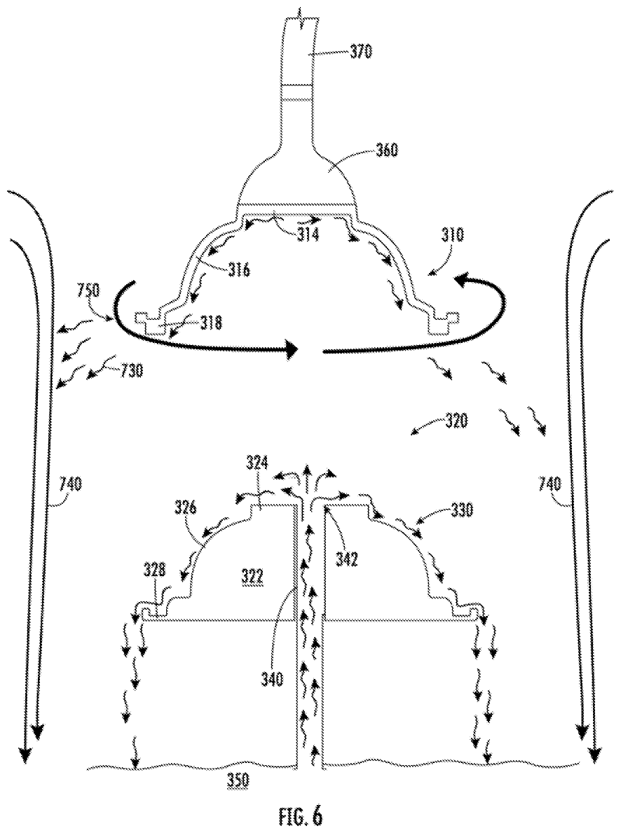

In this embodiment, the container 310 may be coated as described herein, moved away from the form factor, and then rotationally spun to coalesce the coating and expel excess liquid coating material. FIG. 6 illustrates a coating method using rotational spin metering and coalescence. In this embodiment, the container 310 may or may not rotationally spin 750 during the coating process, as described above. In an embodiment, the container 310 may rotationally spin 750 after the coating process is complete and the container 310 is separated from the form factor 322 (in addition to or alternative to any spinning that may occur during coating). In this embodiment, the excess coating 730 which was disposed on the container 310 is spun off of the container 310 due to the centrifugal forces created by the rotational spin 750. The excess coating 730 may be spun into the reservoir 350 or may be spun into a sidewall of the coating device. The sidewall of the coating device may allow any excess coating to drip downwardly into the reservoir 350.

In a particular embodiment, the excess coating 730 may be spun into a curtain 740 of flowing coating material. In an embodiment, the curtain 740 of flowing coating material surrounds the coating device 320. In an embodiment, the curtain 740 of flowing coating material feeds the excess coating 730 into the reservoir 350. Thus, through this process, the rotational spinning of the container will expel the excessive coating from the container interior, which can then be recovered and reapplied to subsequent containers.

Likewise, with reference to FIG. 11, in an embodiment, the container may be spray coated and simultaneously and/or sequentially rotationally spun to coalesce the coating and expel excess liquid coating material. In this embodiment, one or more spray coating devices 1005 may be utilized. The container 1010 may be retained on a device which allows for (1) retention (i.e., vacuum/suction); (2) movement (i.e., robotic); and/or (3) spinning (i.e., rotational). The device may spin the container during the spray coating application, in an embodiment. The one or more spray coating devices 1005 may be directed to the interior of the container 1010. In an embodiment, the one or more spray coating devices 1005 may be directed to the base wall and/or sidewalls of the container 1010. In an embodiment, at least one spray coating device 1005 may be directed toward the base wall and at least one spray coating device 1005 may be directed toward the sidewall of the container. In an embodiment, the spray coating devices1005 may be stationary and the container 1010 is spun during the coating process.

In an embodiment, the rotational spinning continues after the spray coating process is complete. That is, for a period of time after the coating process is complete, the rotational spinning continues for the purpose of metering and/or coating coalescence. In an embodiment, the speed of spinning during coating may be the same as the speed of spinning during metering and/or coalescence. In an embodiment, the speed of spinning during coating may be different from the speed of spinning during metering and/or coalescence. In an embodiment, the speed of spinning during coating may be less than the speed of spinning during metering and/or coalescence. In an embodiment, the speed of spinning during metering and/or coalescence may be greater than the speed of spinning during coating.

In an embodiment, the spray coating with a liquid coating material may occur for approximately 1 (one) to 10 (ten) seconds while rotationally spinning the article. In another embodiment, the spray coating with a liquid coating material may occur for approximately 1.25 seconds while rotationally spinning the article. In another embodiment, the spray coating with a liquid coating material may occur for approximately 6 (six) seconds while rotationally spinning the article. In an embodiment, the rotational spinning may continue for approximately 3 (three) to 10 (ten) seconds after the coating process is complete. In another embodiment, the rotational spinning may continue for approximately 6 (six) seconds after the coating process is complete.

In an embodiment the spray coating device(s) may operate at between about 10 PSI and 50 PSI fluid pressure. In another embodiment the spray coating device(s) may operate at about 20 PSI fluid pressure. In another embodiment the spray coating device(s) may operate at about 40 PSI fluid pressure. In another embodiment the spray coating device(s) may operate at about 42 PSI fluid pressure.

In an embodiment the spray coating device(s) may operate at between about 5 PSI and 40 PSI atomizing air. In another embodiment the spray coating device(s) may operate at about 10 PSI atomizing air. In another embodiment the spray coating device(s) may operate at about 29 PSI atomizing air. In another embodiment the spray coating device(s) may operate at about 30 PSI atomizing air.

In an embodiment, the spray coating device may comprise a 0.5 mm spray nozzle. In an embodiment, the spray coating device may comprise a 0.3 mm spray nozzle. In an embodiment, a 0.5 mm spray nozzle may be directed at the interior sidewalls of an article and a 0.3 mm spray nozzle may be directed at the interior bottom/base wall of an article.

In another embodiment, the spray coating device may comprise a spray nozzle having a nozzle fan pressure of between about 5 PSI and 15 PSI. In another embodiment, the spray coating device may comprise a spray nozzle having a nozzle fan pressure of 8.7 PSI. In another embodiment, the spray coating device may comprise a spray nozzle having a nozzle fan pressure of 10 PSI.

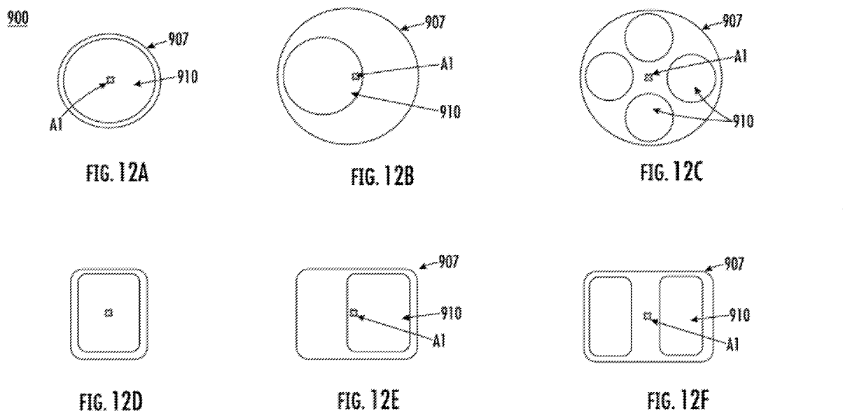

In some embodiments, illustrated in FIGS. 12A-F, an article 910 may be moved to a rotation table 907 for rotational spinning. In some embodiments, the article may be spun about the article's 910 center of gravity, center of radial symmetry, or may be offset from one or both of the center of gravity and/or the center of radial symmetry. In this regard the article 910 may be positioned centered on an axis A1, illustrated in FIGS. 12A and 12D. In other embodiments, illustrated in FIGS. 12B and 12E the article 910 may be positioned off center of the axis A1. In other embodiments, illustrated in FIGS. 12C and 12F, multiple articles 910 may be placed around the axis A1 about the center of the rotation table 907. In each configuration the rotation table 907, or other rotational device may rotate the article(s) 910 to meter and/or coalesce the coating material.

In an embodiment, the rotational spinning of either the rotation table 907, or article 910 may occur at 500 RPM or greater. In another embodiment, the rotational spinning may occur at 540 RPM or greater. In another embodiment, the rotational spinning may occur at 560 RPM or greater. In still another embodiment, the rotational spinning may occur at 600 RPM or greater. In a further embodiment, the rotational spinning may occur at 800 RPM or greater. In a still further embodiment, the rotational spinning may occur at 1000 RPM or greater.

In an embodiment, the coat weight using rotational spinning as a method of metering is self-regulating because at a certain RPM, spin time, and at certain surface properties, the coating viscosity and surface tension settle into a low energy state for the system. Accordingly, in certain embodiments, the metering properties and coat weight are easier to control than when using other metering methods.

The rotational spinning method of metering may be particularly useful in avoiding premature drying due to forced air and/or avoiding visually detectable ripples and waves which can be caused by pressurized air. Further, in this method, the excess coating which is expelled from the surface of the article can be easily collected in a controlled manner, which is not always the case with pressurized air knives or the like. The rotational spinning method of metering may additionally reduce the time required for coating, as compared with other methods. In some embodiments, the rotational spinning method of metering may thin out the coating material itself via shear thinning, such that the initial application of the coating need not be as precise as is required in other coating methods.

It should be understood that the coating methods could be used with any container, made from any material. For example, the coating methods could be used in connection with a fiber-based container, a polymeric or plastic container, a pressed paperboard container, a fiberglass container, a folded paperboard container, a corrugated cardboard container, a metal container, a glass container, or any other container known in the art. The methods could be used with a thermoformed container, a spirally-wound container, a compression-molded container, an injection-molded container, a fiberglass container, etc. In addition, any of the coating, metering, or coalescence embodiments set forth herein could be utilized with a symmetrical article (i.e., a bowl) or a non-symmetrical article.

In an embodiment, the coating methods described herein may enable the coating of liquid coating materials onto three-dimensional articles in a manner that maximizes uniform coverage, minimizes coat weight, and minimizes liquid coating material losses. A broad range of coating materials may be utilized with the fountain coating method, described herein, as the coating formulation does not have to be formulated for spraying. The methods of the invention may provide a higher transfer efficiency (i.e., lower material losses) than known coating methods, such as spraying, for example.

In certain embodiments, the dry coating comprises about 4% to about 6% of the total mass of the container. In some embodiments, the dry coating comprises less than about 6% of the total mass of the container. In some embodiments, the dry coating comprises less than about 5% of the total mass of the container. In some embodiments, the dry coating comprises less than about 4% of the total mass of the container.

Because an objective of this invention is to provide an environmentally beneficial package, it is important to note that the low coating weights enable the used package to enter recycling and composting re-use processes. The thin coating does not prevent a paper-based container, for example, from being recycled in ordinary recycling streams after use. Of course, the low coat weights also provide cost benefits and process benefits, such as faster drying.

### Coating Material

Any coating material known in the art may be utilized herein. In an embodiment, the coating material comprises a liquid coating material. In an embodiment, the coating material is diluted with water. In an embodiment, the coating material is commercially available. Examples of useful coatings may include latexes, dispersions of polymers of ethylene, propylene, butadiene, styrene, vinyl acetate, vinyl chloride, vinylidene chloride, vinyl alcohol, amides, acrylic, polyester, epoxies, epoxy esters, hydrocarbon resins and mixtures or copolymers thereof.

In some embodiments, the coating material may include substantially solvent-based or solvent-free compositions. For example, the coating material may include aqueous PET coatings and polyester-emulsions (such as S-1600-L from Synthetic Natural Polymers); aqueous acrylic, acrylic latex, vinyl-acrylic and styrene-acrylic emulsions (e.g., Michem Coat 51, 55 and X300AF, Galacryl 89.429.10 from Actega); aqueous urethane and urethane co-polymer emulsions (e.g., Verdecoat from Mantrose-Haeuser, CK-74HV-120 or CK-81P-1 from Cork Industries); aqueous polyolefin dispersions (e.g., HME-261 from Mica Corp.); aqueous coatings based on bio-polymers (e.g., chitosan coacervate, chitosan carboxymethylcellulose, polylactic acid (PLA), polyhydroxyalkanoates (PHAs), polybutylene succinate (PBS), polyethylene furanoate (PEF), Vyloecol by Toyobo); aqueous coatings based on modified cellulose and nanofibrillated cellulose (including composites of cellulose and cellulose/pigment matrices); aqueous coatings based on modified starches (e.g., FilmKote 370 from Ingredion, EcoSphere 2108 from EcoSynthetix); and/or aqueous coatings based on plant byproducts (such as leaf cuticles, bark/cork, and pollen casings), for example—these materials may be processed to yield polymers (e.g., wax-filled polyesters, cutin, suberin, sporollenein, xylophane, Skalax from Seelution, Topscreen from Topchim).

Optional components of the coating may include wax, mineral filler or colorants such as clay, titanium dioxide, calcium carbonate, silica, and organic or inorganic acids or bases. Other optional ingredients are natural or derivatized starch, silicones, oil repellants, defoamers, wetting agents, color pigments, fillers, thickeners and other additives known in the art. Preferably, the coating material is a water dispersion or emulsion containing about 15% to about 65% total solids.

In an embodiment, the coated container of the invention can survive a range of temperatures, from deep freeze temperatures to temperature at which food is heated in a conventional or microwave oven, such as from about negative twenty degrees Fahrenheit (−20° F.) to about four hundred twenty-five degrees Fahrenheit (425° F.). In an embodiment, the coated containers of the invention are dual ovenable, that is, the containers are ovenable in either a conventional oven or in a microwave oven.

In an embodiment, the coating contains organic polymers. In an embodiment, the coating is highly polar relative to a fiber-based container to be coated.

In an embodiment, the coating confers improved (i.e., reduced) water vapor transmission and/or liquid water transmission rates on a fiber-based container. Water vapor transmission rate (WTR) is a measurement that indicates the potential for providing an adequate shelf life for both frozen and refrigerated food containers. Liquid water resistance provides adequate shelf life for refrigerated meals as well as plays a part in resisting stains during meal reheating.

In an embodiment, the coating may contain one or more additives that modify surface tension and/or shift the dispersive to polar ratio. In some embodiments, additives may comprise polyethylene glycol (“PEG”), polypropylene glycol (“PPG”), glycerin, and/or other polyglycols known in the art. In an embodiment, the coating may comprise one or more surfactants. Any surfactants known in the art may be utilized in this embodiment. In an embodiment, the coating may comprise one or more oils, emulsified oils, vegetable oils, and/or silicone oils.

### EXAMPLES

### Example 1—Air Knife

Phase One: twenty (20) container samples were coated using the first coating process without an air knife. The container samples were contacted with the liquid coating material via the first coating device for an average of about 10 seconds.

The first coating device comprised a pneumatically-driven positive displacement pump used to deliver the liquid coating material onto a form factor. The form factor was configured as an inverse of the container interior. That is, the form factor outer surface nested against the inner surfaces of the container. A vacuum-end effector was utilized on an ABB™ 6-axis industrial robot, to retain the container via vacuum and move the container into position against the coating device and away from the coating device after coating.

After drying of the containers, the average coat weight was calculated to be 5.4 grams (dry). The average weight of the containers prior to coating was 18.1 grams and after coating was calculated to be 23.5 grams with a final fiber content of 77%.

Phase Two: seventeen (17) container samples were coated using the first coating process set forth above with use of an Exair air knife. The container samples were contacted with the liquid coating material via the first coating device for an average of about 10 seconds and an air knife was then used to force air into the container for about 15 seconds.

The average coat weight was calculated to be 4.0 grams (dry). The average weight of the containers prior to coating was 18.1 grams and after coating was calculated to be 22.1 grams with a final fiber content of 81%. The air pressure of the air knife was adjusted between each sample, so this average result is for reference purposes only.

The testing results of Phase Two are shown in Chart 1, below. The dry weight measurements are shown below those of the wet weight measurements. That is, the lower line in the line chart represents the dry weight measurements.

In addition to the weight measurements, the inventors analyzed qualitative aspects of the coating process. For example, one hundred percent (100%) of the Phase Two samples had zero pin hole defects. Said alternatively, none of the Phase Two samples contained pin hole defects in the coating. Only three of the samples analyzed during Phase One and Phase Two had minor rim defects, which were observed after pouring vegetable oil into the bowl and then pouring it out of the bowl. In these samples with rim defects, the oil could be seen to penetrate the container fibers, darkening the edge of the rim.

It was found that the velocity of the air knife impacted the coating texture and final appearance of the coating. The velocity of the air knife did not compromise the full coverage of the coating.

The trial successfully demonstrated the feasibility of the coating and air knife process to deliver a coated, bowl which is free of defects. The use of the air knife assured full coverage, aided in reduction in coating weight, and added some initial drying to the process. It is believed, however, that the air knife reduced the coating weight via an overall loss of moisture and increased cycle time. Utilizing the air knife with a higher velocity and/or for a longer time period is believed to drive away moisture without removing the solids component of the coating from the bowl.

### Example 2—Dilutions and Varied Air Knife Embodiments

In this example, thirty (30) bowls were tested and the outliers were removed, with twenty-one (21) bowls remaining. Samples 1-01 through 1-05 were coated with a liquid coating and subjected to one rotation of an air knife. Samples 1-06 through 1-10 were coated with a liquid coating and subjected to two rotations of an air knife. Samples 1-11 through 1-15 were coated with a liquid coating and subjected to two rotations of an air knife and then dried upside down. Samples 1-16 through 1-19 were coated with a liquid coating, subjected to two rotations of an air knife, allowed to drip while in a single rotation which allows liquid coating to flow around the bowl, and then dried upside down. The ratio of coating to water for samples 1-01 through 1-19 was 2:1. Samples 2-01 through 2-09 were coated with the same liquid coating at a ratio of 4:3 (4 parts coating, 3 parts water), subjected to two rotations of an air knife, allowed to drip while in two rotations, and then dried upside down. Each bowl was dried upside down for approximately ten (10) minutes to avoid coating material gathering in the base of the bowl and/or creating any blistering of the coating. The bowls were then exposed to ambient room temperature for twenty-four (24) hours for full drying and curing.

The mass of the coatings are set forth in Chart 2. As can be seen, the final dry coating comprised approximately 4% to 8% of the total mass of the bowls. In some embodiments, the dry coating comprised 5% to 6% of the total mass of the bowls. The average dry coating comprised 5.43% of the total mass of the bowl. The average wet coating mass comprised 5.9 g. The average dry coating mass comprised 1.02 g.

CHART 2

| | Bowl | Wet | Dry | Wet | Dry | % |
|---|---|---|---|---|---|---|
| Bowl | Mass | Bowl | Bowl | Coating | Coating | Mass |
| # | (g) | Mass (g) | Mass (g) | Mass (g) | Mass (g) | Coating |
| 1-02 | 16.7 | 23.6 | 17.75 | 6.9 | 1.05 | 6% |
| 1-04 | 18.8 | 25.4 | 19.93 | 6.6 | 1.13 | 6% |
| 1-05 | 18.2 | 24.5 | 19.19 | 6.3 | 0.99 | 5% |
| 1-06 | 18.1 | 24 | 19.12 | 5.9 | 1.02 | 5% |
| 1-07 | 18.5 | 24.6 | 19.53 | 6.1 | 1.03 | 5% |
| 1-08 | 17.9 | 23.95 | 18.95 | 6.05 | 1.05 | 6% |
| 1-10 | 18.1 | 24.48 | 19.16 | 6.38 | 1.06 | 6% |
| 1-11 | 18.32 | 23.96 | 19.21 | 5.65 | 0.89 | 5% |
| 1-12 | 18.49 | 24.81 | 19.44 | 6.32 | 0.95 | 5% |
| 1-14 | 18.72 | 24.57 | 19.6 | 5.85 | 0.88 | 4% |
| 1-15 | 18.74 | 24.35 | 19.59 | 5.61 | 0.85 | 4% |
| 1-16 | 16.39 | 22.76 | 17.8 | 6.37 | 1.41 | 8% |
| 1-17 | 17.61 | 23.64 | 18.52 | 6.03 | 0.91 | 5% |
| 1-18 | 18.32 | 24.32 | 19.22 | 6 | 0.90 | 5% |
| 1-19 | 17.16 | 23.13 | 18.02 | 5.97 | 0.86 | 5% |
| 2-01 | 18.3 | 24.35 | 19.42 | 6.05 | 1.12 | 6% |
| 2-03 | 18.9 | 24.71 | 20.00 | 5.81 | 1.10 | 6% |
| 2-05 | 17.95 | 23.85 | 19.12 | 5.9 | 1.17 | 6% |
| 2-06 | 17.8 | 22.42 | 18.89 | 4.62 | 1.09 | 6% |
| 2-08 | 17.95 | 22.72 | 18.94 | 4.77 | 0.99 | 5% |
| 2-09 | 19.03 | 23.97 | 20.06 | 4.94 | 1.03 | 5% |

### Example 3—Dilutions

In this example, fifty (50) bowls were tested with varied ratios of coating to water (i.e., dilution ratios), as set forth in Chart 3. Each bowl was fountain coated. The bowl was then rotated to allow the fluid to flow around the bowl. The bowl was then exposed to an air knife to wick away excess coating material. Each bowl was dried upside down for approximately ten (10) minutes to avoid coating material gathering in the base of the bowl and/or creating any blistering of the coating. The bowls were then exposed to ambient room temperature for twenty-four (24) hours for full drying and curing.

The mass of each of the coatings is set forth in Chart 3. As can be seen, the final dry coating comprised approximately 8% to 12% of the total mass of the bowls, depending on the ratio of coating to water.

CHART 3

| | | | Wet | Dry | Wet | Dry | |
|---|---|---|---|---|---|---|---|
| | | Bowl | Bowl | Bowl | Coating | Coating | % |
| Bowl | Ratio | Mass | Mass | Mass | Mass | Mass | Mass |
| # | Coating:Water | (g) | (g) | (g) | (g) | (g) | Coating |
| 3.1 | 3:4 | 18.3 | 24.9 | 19.8 | 6.6 | 1.5 | 7.58% |
| 3.2 | 3:4 | 18.7 | 25.3 | 20.2 | 6.6 | 1.5 | 7.43% |
| 3.3 | 3:4 | 18.7 | 25.5 | 20.5 | 6.8 | 1.8 | 8.78% |
| 3.4 | 3:4 | 18.8 | 25.6 | 20.6 | 6.8 | 1.8 | 8.74% |
| 3.5 | 3:4 | 18.0 | 24.6 | 19.7 | 6.6 | 1.7 | 8.63% |
| 3.6 | 3:4 | 17.9 | 24.5 | 19.6 | 6.6 | 1 . . . 7 | 8.67% |
| 3.7 | 3:4 | 18 | 24.6 | 19.8 | 6.6 | 1.8 | 9.09% |
| 3.8 | 3:4 | 18.4 | 25.2 | 20.2 | 6.8 | 1.8 | 8.91% |
| 3.9 | 3:4 | 18.3 | 25.2 | 20.0 | 6.9 | 1.7 | 8.50% |
| 3.10 | 3:4 | 18.3 | 25.2 | 20.1 | 6.9 | 1.8 | 8.96% |
| Sample 3 | | | | | 6.72 | 1.71 | 8.53% |
| AVG | | | | | | | |
| 4.1 | 1:1 | 19.2 | 25.3 | 21.1 | 6.1 | 1.9 | 9.00% |
| 4.2 | 1:1 | 18.9 | 25.2 | 20.9 | 6.3 | 2.0 | 9.57% |
| 4.3 | 1:1 | 19 | 25.1 | 20.9 | 6.1 | 1.9 | 9.09% |
| 4.4 | 1:1 | 18.9 | 25.0 | 20.7 | 6.1 | 1.8 | 8.70% |
| 4.5 | 1:1 | 19.2 | 25.3 | 21.1 | 6.1 | 1.9 | 9.00% |
| 4.6 | 1:1 | 18.4 | 25.2 | 20.3 | 6.8 | 1.9 | 9.36% |
| 4.7 | 1:1 | 18.4 | 25.2 | 20.3 | 6.8 | 1.9 | 9.36% |
| 4.8 | 1:1 | 17.8 | 24.7 | 19.7 | 6.9 | 1.9 | 9.64% |
| 4.9 | 1:1 | 19 | 25.6 | 20.8 | 6.6 | 1.8 | 8.65% |
| 4.10 | 1:1 | 18.5 | 25.7 | 20.4 | 7.2 | 1.9 | 9.31% |
| Sample 4 | | | | | 6.50 | 1.89 | 9.17% |
| AVG | | | | | | | |
| 5.1 | 5:4 | 18.7 | 24.8 | 20.8 | 6.1 | 2.1 | 10.10% |
| 5.2 | 5:4 | 19.2 | 26.6 | 21.7 | 7.4 | 2.5 | 11.52% |
| 5.3 | 5:4 | 19.1 | 25.8 | 21.5 | 6.7 | 2.4 | 11.16% |
| 5.4 | 5:4 | 19.5 | 26.5 | 21.8 | 7.0 | 2.3 | 10.55% |
| 5.5 | 5:4 | 20.1 | 26.6 | 22.4 | 6.5 | 2.3 | 10.27% |
| 5.6 | 5:4 | 19.8 | 26.8 | 21.9 | 7.0 | 2.1 | 9.59% |
| 5.7 | 5:4 | 19.8 | 26.7 | 22.0 | 6.9 | 2.2 | 10.00% |
| 5.8 | 5:4 | 17.8 | 24.6 | 19.9 | 6.8 | 2.1 | 10.55% |
| 5.9 | 5:4 | 17.6 | 24.4 | 19.7 | 6.8 | 2.1 | 10.66% |
| 5.10 | 5:4 | 17.9 | 24.8 | 20.1 | 6.9 | 2.2 | 10.95% |
| Sample 5 | | | | | 6.81 | 2.23 | 10.53% |
| AVG | | | | | | | |
| 6.1 | 3:2 | 17.8 | 24.8 | 19.8 | 7.0 | 2.0 | 10.10% |
| 6.2 | 3:2 | 17.5 | 24.0 | 19.4 | 6.5 | 1.9 | 9.79% |
| 6.3 | 3:2 | 18.8 | 25.1 | 21.0 | 6.3 | 2.2 | 10.45% |
| 6.4 | 3:2 | 19.3 | 25.9 | 21.5 | 6.6 | 2.2 | 10.23% |
| 6.5 | 3:2 | 18.8 | 25.7 | 21.1 | 6.9 | 2.3 | 10.90% |
| 6.6 | 3:2 | 18.4 | 25.9 | 20.9 | 7.5 | 2.5 | 11.96% |
| 6.7 | 3:2 | 18.1 | 25.6 | 20.6 | 7.5 | 2.5 | 12.14% |
| 6.8 | 3:2 | 18.4 | 25.9 | 207 | 7.5 | 2.3 | 11.11% |
| 6.9 | 3:2 | 18.4 | 26.0 | 20.8 | 7.6 | 2.4 | 11.54% |
| 6.10 | 3:2 | 18.8 | 25.7 | 20.2 | 6.9 | 1.4 | 6.93% |
| Sample 6 | | | | | 7.03 | 2.17 | 10.52% |
| AVG | | | | | | | |
| 7.1 | 2:1 | 19.4 | 26.4 | 21.3 | 7.0 | 1.9 | 8.92% |
| 7.2 | 2:1 | 18.6 | 25.7 | 20.9 | 7.1 | 2.3 | 11.00% |
| 7.3 | 2:1 | 19.4 | 26.4 | 21.6 | 7.0 | 2.2 | 10.19% |
| 7.4 | 2:1 | 18.8 | 26.0 | 21.1 | 7.2 | 2.3 | 10.90% |
| 7.5 | 2:1 | 18.9 | 26.0 | 21.2 | 7.1 | 2.3 | 10.85% |
| 7.6 | 2:1 | 18.4 | 25.8 | 20.8 | 7.4 | 2.4 | 11.54% |
| 7.7 | 2:1 | 18.8 | 26.9 | 21.5 | 8.1 | 2.7 | 12.56% |
| 7.8 | 2:1 | 18.6 | 26.4 | 21.3 | 7.8 | 2.7 | 12.68% |
| 7.9 | 2:1 | 18.8 | 26.3 | 21.3 | 7.5 | 2.5 | 11.74% |
| 7.10 | 2:1 | 18.1 | 25.9 | 20.6 | 7.8 | 2.5 | 12.14% |
| Sample 7 | | | | | 7.40 | 2.38 | 11.25% |
| AVG | | | | | | | |

### Example 4—Rotational Spinning

In this example, molded fiber bowls were spray coated with liquid coating for 6 (six) seconds at 20 PSI fluid pressure and 10 PSI atomizing air while spinning at 560 RPM. The bowls were then spun for an additional six (6) seconds at 560 RPM (without applying coating) to coalesce the coating and remove excess coating from the bowls. The coat weight and pinhole data are set forth below.

Chart 4

| Uncoated Bowl | Coated Bowl | Coat | |
|---|---|---|---|
| Weight | Weight | Weight | Pinholes |
| 16.1 | 21.4 | 5.3 | 0 |
| 16.5 | 21.8 | 5.3 | 0 |
| 16.1 | 21.4 | 5.3 | 0 |
| 16.3 | 21.6 | 5.3 | 0 |
| 17 | 22.4 | 5.4 | 0 |
| 16.2 | 21.5 | 5.3 | 0 |
| 16.3 | 21.6 | 5.3 | 0 |
| 16.7 | 21.9 | 5.2 | 0 |
| 16.6 | 21.9 | 5.3 | 0 |
| 16.7 | 22.1 | 5.4 | 0 |
| 16.7 | 21.9 | 5.2 | 0 |
| | | 5.3 | Average |
| | | 0.063 | Standard |
| | | | Deviation |

As can be seen, the average coat weight was 5.3 grams with zero pinholes and a standard deviation of 0.063. The 95% confidence interval for the coat weight for this sample set is between 5.26 grams and 5.34 grams.

### Example 5

In this example, one liquid coating spray nozzle (0.5 mm) was aimed at the interior sidewalls of a molded fiber bowl and a second liquid coating spray nozzle (0.3 mm) was aimed at the bottom interior wall of a molded fiber bowl. The nozzles were sprayed simultaneously for 1.25 seconds at a fluid pressure of 42 PSI, an air pressure of 29 PSI, and a nozzle fan pressure of 8.7 PSI. The bowl was simultaneously rotated at 600 RPM. 50 bowl samples were tested. The wet weight range of the coating was 4.9 g to 6.4 g. The average wet weight was 5.9 g. The results are shown graphically in Chart 5.

There were zero pinholes on 49 of the 50 samples. The transfer efficiency of the coating was approximately 70%. The bowls were dried at approximately 175° F. for approximately 1.5 minutes and then cured for an additional 0.5 to 1 min at 255° F.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged in whole or in part. Furthermore, those of ordinary skill in the art will appreciate that the foregoing description is by way of example only, and is not intended to limit the invention so further described in such appended claims. Therefore, the spirit and scope of the appended claims should not be limited to the description of the versions contained therein.

What is claimed is:

1. A method of coating a three-dimensional article comprising:
depositing a quantity of a liquid coating material onto a surface of a form factor;
contacting a surface of the three-dimensional article with the form factor surface, wherein the form factor surface is configured to nest with the three-dimensional article; and
coalescing the liquid coating material on the surface of the three-dimensional article for uniform coverage.

2. The method of claim 1, wherein coalescing the liquid coating material comprises one of rotating the three-dimensional article about an axis at a speed sufficient to remove excess coating from the three-dimensional article, aiming a stream of air at the surface of the three-dimensional article, utilizing ultrasonic waves, vacuuming excess liquid coating or heating the three-dimensional article.

3. The method of claim 1, wherein coalescing the liquid coating material further comprises metering the liquid coating material on the surface of the three-dimensional article.

4. The method of claim 1, further comprising rotating the three-dimensional article on the form factor surface.

5. The method of claim 1, wherein the depositing step comprises flood coating the surface of the three-dimensional article.

6. The method of claim 1, wherein the depositing step comprises:
directing the liquid coating material upwardly over the form factor such that the liquid coating material flows downwardly over the form factor.

7. The method of claim 1, wherein the surface of the three-dimensional article is concave.

8. The method of claim 1, wherein the three-dimensional article is symmetrical.

9. The method of claim 1, wherein the three-dimensional article is asymmetrical.

10. The method of claim 1, wherein the three-dimensional article is retained by a vacuum, wherein the vacuum creates a pressure adjacent a surface opposite the surface of the three-dimensional article to be coated which is lower than the pressure adjacent the surface of the three-dimensional article to be coated.

11. A device for coating a three-dimensional article, the device comprising:
a form factor defining a form factor surface configured to nest with a surface of the three-dimensional article, wherein the form factor further comprises at least one opening in the form factor surface;
means for retaining the three-dimensional article; and
means for supplying a liquid coating material through the at least one opening, wherein the liquid coating material is configured to flow over the form factor surface.

12. The device of claim 11, wherein the means for retaining the three-dimensional article is configured to move the three-dimensional article into contact with the form factor surface.

13. The device of claim 12, wherein the form factor surface contacts a surface of the three-dimensional article, wherein the contact between the form factor surface and the surface of the three-dimensional article coats the surface of the three-dimensional article with the liquid coating material.

14. The device of claim 11, wherein the means for retaining the three-dimensional article is configured to rotate.

15. The device of claim 11, wherein the form factor is formed of one of an elastic material, a semi elastic material, a plurality of fabric strands or a sponge.

16. The device of claim 11, wherein the form factor is formed of a semi elastic material.

17. The device of claim 11, wherein the form factor further comprises at least one vacuum opening, wherein the at least one vacuum opening and the at least one opening are distinct.

18. A system for coating an article with a coating material, the system comprising:
a coating device comprising:
a form factor comprising a central column defining a through hole; and
a tubular column extending though the central column;
a pump in fluid communication with the tubular column;
a reservoir comprising the coating material, wherein the reservoir is in fluid communication with the pump; and
retention means configured to move the article into and out of contact with the coating device.

19. The system of claim 18, wherein the central column and the tubular column are liquid tight.

20. The system of claim 18, wherein the central column is one of a tube, a pipe, a hose, or a column.

21. The system of claim 18, wherein the pump provides a pump pressure configured to displace the coating material over the form factor.

22. The system of claim 18, wherein the pump provides a pump pressure configured to provide an even flow of the coating material over the form factor.

23. The system of claim 18, wherein the retention means is a vacuum device.

24. The system of claim 18, wherein the retention means comprises one of pneumatically-actuated mechanical grippers, solenoid-actuated grippers, centrifugal-actuated hinged sling weight grippers, or spring-loaded gripper; and a mechanical ejector.

25. The system of claim 18, wherein the retention means device is configured to contact an exterior surface of the article.

26. The system of claim 18, wherein the form factor further comprises a plurality of outlet holes, and a plurality of central columns, wherein each of the plurality of central columns corresponds to one of the plurality of outlet holes.

27. The system of claim 18, wherein the form factor further comprises a plurality of vacuum inlet holes.
